(19) United States
(12) Patent Application Publication
(10) Pub. No.: US 2017/0172179 A1
(43) Pub. Date: Jun. 22, 2017

(54) METHOD FOR PRODUCING BAKED ANIMAL FEED AND BAKED ANIMAL FEED

(71) Applicant: Hans-Juergen DEUERER, Bretten (DE)

(72) Inventor: Hans-Juergen DEUERER, Bretten (DE)

(21) Appl. No.: 15/310,123

(22) PCT Filed: May 19, 2015
(86) PCT No.: PCT/EP2015/060978

§ 371 Date: Nov. 10, 2016

(30) Foreign Application Priority Data
May 19, 2014 (DE) 10 2014 107 057.7

(51) Int. Cl. A23K 50/45; A23K 10/20; A23K 10/26; A23K 40/25; A23K 20/163; A23K 20/26; A23K 40/00; A23K 10/16; A23K 10/30

(52) U.S. Cl. CPC A23K 50/45; A23K 10/16; A23K 10/20; A23K 10/26; A23K 10/30; A23K 20/163; A23K 20/26; A23K 40/00; A23K 40/25

(57) ABSTRACT

The invention relates to a method for producing baked animal feed containing an animal feed meat product which is, optionally, in pieces. The invention also relates to baked animal feed obtained according to said method, to the use of the claimed baked animal feed as animal feed for carnivorous animals.

The invention relates to a method for producing baked animal feed. The invention further relates to baked animal feed obtainable by the method according to the invention and to the use of the baked animal feed according to the invention as feed for carnivorous animals.

Carnivorous animals such as dogs and cats, which are kept as pets, are often not, fed a species-appropriate diet.

In nature, these animal species chiefly feed on prey, i.e., they consume animal proteins in the form of meat.

In preparing feed products for carnivorous animals, it is nutritionally appropriate to provide a high protein content with a simultaneously low carbohydrate content.

In addition to the principal feed given as a main meal in the form of dry, semi-moist, or moist feed, there is also increasing consumer demand for snacks to be used for special functions such as dental care or for raising and training purposes.

Above all, the snacks known from the prior art (in the area of baked animal feed) for carnivorous animals consist almost entirely of cereal, vegetables, oils and fats and contain little—if any—animal protein in the form of meat meal.

Carnivorous animals not fed a species-appropriate diet have problems such as increased susceptibility to metabolic diseases.

There is therefore a need to provide a nutritionally suitable feed—particularly for use as a snack—that is readily accepted by carnivores.

The object is achieved by a method for producing baked animal feed containing an animal feed meat product, optionally in pieces, wherein
a. a cutter for producing an animal feed precursor is charged with at least the following ingredients, which have a temperature equal to or lower than +25° C.: at least one component of the meat group,
b. the ingredients are minced to form a feed precursor with a moisture content of between 40 wt % and 80 wt %,
c. optionally, the minced feed precursor is optionally shaped by extrusion,
d. the minced and optionally shaped feed precursor is optionally heated to a temperature of between 70° C. and 120° C. so that an animal feed meat product is obtained,
e. the animal feed meat product is added to a baked product dough, and
f. the baked product dough containing the animal feed meat product to a moisture content of the baked animal feed of between 2 wt % and 20 wt %.

By means of the method according to the invention, baked animal feed is provided that is characterized by being particularly well-accepted by carnivorous pets.

A “baked animal feed” is understood to refer to a feed containing a baked product component, i.e. a cereal-containing dough that is optionally heat-dried, and a content of at least 30 wt % of meat relative to the total weight of the feed precursor or the baked animal feed.

“Meat” is understood to refer to all meat parts of slaughtered warm-blooded land animals, fresh or preserved by a suitable method, and all products of processing of the bodies of land animals that are allowed in animal feed processing.

In an advantageous embodiment, the meat content of the feed precursor or the baked animal feed is between 30 wt % and 95 wt %, preferably between 40 wt % and 80 wt %, and more preferably between 60 wt % and 70 wt %. This embodiment is advantageous in that the baked animal feed is consumed by animals particularly readily, wherein acceptance further increases with increasing meat content.

In an advantageous embodiment, the ingredients for producing the feed precursor have a temperature in the range of −18° C. to +7° C. This embodiment is advantageous in that the mincing time required until the protein contained in the precursor disintegrates (i.e. the proteins are denatured by destruction of the cell membranes) and a bonded feed precursor is produced is only approximately 5 to 15 minutes, e.g. approximately 5 to 10 minutes. Primarily the cell structures, above all the cell membranes, are ruptured and the proteins are denatured. Accordingly, the method is particularly economical with respect to the required expenditure of time and energy. By means of mincing, this embodiment provides an animal feed precursor whose temperature is up to approximately 15° C.

In a further advantageous embodiment, additional cooling is carried out, for example by adding ice or cooling the cutter by means of cooling elements, so that a maximum temperature of approximately 5° C. is reached. At a maximum temperature of the produced feed precursor of approximately 5° C., the texture of said processor is particularly homogenous.

“Cutter” and “mincing” are understood in the present invention to mean that the components contained in the cutter are finely and minutely crushed. This means that the particle size distribution is in the range of 10 mm to 0.1 mm or smaller. Mincing is characterized by a process in which the cell membranes of as many cells as possible are damaged so as to obtain a fine, homogeneous mass. Corresponding “cutters” are known to the person skilled in the art. In this process, the blades are used at a speed of at least 60 rpm, for example at least 200 rpm, e.g. at least 2860 rpm. This causes at least partial denaturing of the proteins during mincing.

The moisture content of the feed precursor can advantageously be between 60 wt % and 70 wt %. The advantage of using a feed precursor with this moisture content of between 60 wt % and 70 wt % is that-if drying is necessary-the drying step can be kept short, so that the nutrients in the baked animal feed can be retained to the greatest extent possible.

In a further advantageous embodiment, the ingredients for producing the feed precursor are used in completely or partially frozen form. Surprisingly, it was found in this case that such a feed precursor provides baked animal feed according to the invention having a high content of nutrients such as vitamins.

In a further advantageous embodiment, the baked product dough contains one or a plurality of the following components: biscuit meal, cereal flour, water, meat-and-bone meal, vegetable flour and/or granulate and/or flakes, natural lignocellulose, pyrophosphate, and/or linseed. Advantageously, various flavors, including species-specific flavors, of the baked animal feed according to the invention can be produced, such as the wheat flavor, spelt flavor, etc.

In a further advantageous embodiment, one or a plurality of components selected from the group of phosphate, salt, plasma and/or gluten are added to the ingredients for producing the feed precursor before mincing. The effect of this addition lies in improving the technical processing properties of the feed precursor.

If the feed precursor is shaped, this can take place by extrusion—i.e. by a thermal process in which the components of the product are decomposed by sudden evaporation of the water contained in the product and are given a particular form by simultaneously being forced through a nozzle.

In principle, shaping of the feed precursor can also be carried out by non-thermal means, in which case the feed precursor should then pass through a steam tunnel.

In a further advantageous embodiment, the animal feed meat product is shaped into optionally irregular pieces and/or pieces having the appearance of meat before addition to the baked product dough, particularly by cutting, tearing, or breaking. The advantage of this embodiment is that the baked animal feed obtainable by the method according to the invention is particularly well-accepted by carnivorous animals.

In a further advantageous embodiment, the ingredients for producing the feed precursor are crushed before charging of the cutter by feeding them through one or a plurality of perforated disks. It has been found in this case that crushing before the mincing process provides a more homogenous feed precursor, and as a result, the mincing process does not have to be excessively prolonged, so that the animal proteins are retained as favorably as possible.

In a further advantageous embodiment, vegetables and/or cereal and/or potatoes and/or glycerol are added to the ingredients for producing the feed precursor before mincing. These further feed components provide better technical processing of the feed, in the sense that the feed precursor is easier to process because it is less tacky. Surprisingly, it was found that the tackiness of the feed precursor can be reduced by adding the above-mentioned further feed components to the ingredients for producing the feed precursor before the mincing process.

In a further advantageous embodiment, additives commonly used in the animal feed industry are added to the baked product dough and/or the feed precursor. In particular, these are flavoring agents, natural or synthetic dyes, inactivated yeasts or yeast extracts, plant extracts and/or concentrates, preservatives, sugars, and/or functional ingredients. Functional ingredients are understood, for example, to be probiotics, but also vitamins, minerals, omega-3 fatty acids, probiotic dietary fiber, and probiotic microorganisms.

Preservatives such as potassium sorbate can be used in the method. For example, potassium sorbate can be used in a concentration of 0.1 wt % to 1 wt % relative to the total weight of the feed precursor. The addition of potassium sorbate in an amount of approximately 0.5 wt % relative to the total weight of the feed precursor results in a minimum shelf life of the baked animal feed according to the invention of approximately 15 to 18 months.

Advantageously, there is no need to use binders such as carrageenan, gelatin, agar agar or pectin. Nor do dairy products or their proteins need to be used. This is advantageous with respect to possible intolerance to dairy products or milk protein.

In a further advantageous embodiment, before drying to obtain the baked animal feed, the baked product dough containing the animal feed meat product is pressed through a die, and this baked product dough is optionally cut by a cutting device, for example into cubes or cuboids.

The baked animal feed according to the invention is obtainable by the method according to the invention.

In an advantageous embodiment, in the baked animal feed according to the invention, the animal feed meat product is partially or completely in the form of visible pieces, which are optionally irregularly shaped and/or have the appearance of pieces of meat. In particular, the animal feed meat product is visible immediately and/or after breaking of the baked animal feed according to the invention. The advantage of this embodiment is that the baked animal feed is particularly well-accepted by carnivorous animals, and the value of the product can be recognized by the animal owner by the visible “pieces of meat” directly on the surface of the baked animal feed according to the invention and/or on the breaking surface of the baked animal feed according to the invention after breaking of the baked animal feed according to the invention. In particular, the animal feed meat product in the baked animal feed can have a mean diameter of approximately 0.5 cm to approximately 1.5 cm.

In a further advantageous embodiment, in the baked animal feed according to the invention, the obtained animal feed meat product is in the form of pieces that are essentially evenly distributed in the baked animal feed. The effect of this embodiment is that the baked animal feed products according to the invention are virtually identical to one another with respect to their contents, particularly the animal proteins.

In a further advantageous embodiment, the baked animal feed according to the invention is dyed in one or a plurality of colors with natural and/or synthetic dyes. This embodiment is extremely well accepted, particularly by the person feeding the animal the baked animal feed according to the invention.

In a further advantageous embodiment, the baked animal feed according to the invention is in the form of biscuits, particularly in lightly sweetened or salted form, for example as cuboids or cubes, or as cakes. The advantage of this embodiment is that acceptance by the animals is particularly strong.

In a further advantageous embodiment, the baked animal feed according to the invention is sealed in a tubular bag package, a hollow shell package, a can, or a box. Advantageously, the specific flavor and the product-specific moisture are achieved for longer than the intended minimum shelf life of the product.

In a further advantageous embodiment, the baked animal feed according to the invention has a moisture content of between 5 wt % and 10 wt %. The advantage of this drier baked animal feed is that it can be handled by the person feeding the animal in a particularly practical manner.

In a further advantageous embodiment, the baked animal feed according to the invention is shaped into biscuits. Surprisingly, it was found that the form of the baked animal feed according to the invention, particularly when the edge length of the biscuits is between 8 mm and 40 mm, and more particularly 22 mm, provides special haptics and subsequent acceptance by the animals.

With the method described above, a new baked animal feed is obtained that consists exclusively of meat to at least 30 wt %, preferably between 30 wt % and 95 wt %, and more preferably between 40 wt % and 80 wt %, for example between 60 and 70 wt % relative to the total weight of the feed precursor.

The baked animal feed according to the invention can be dyed in one or multiple colors with natural dyes. It has been shown that this measure further increases acceptance of the product by the animal owner.

The baked animal feed according to the invention can advantageously be used or sold as cat food, dog food, or feed for other carnivorous pets in the form of complete animal feed or snacks.

In the following, the invention is described in further detail with respect to an illustrative embodiment that serves only to explain a possible embodiment and by no means limits the scope of the invention.

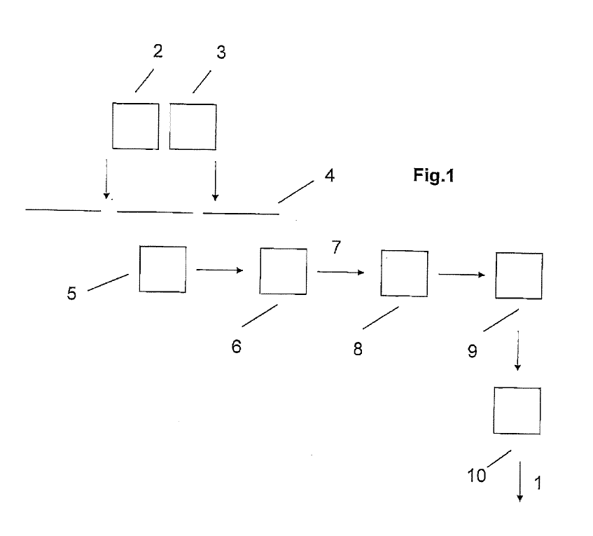

FIG. 1, which is the only figure, shows a schematic diagram for producing a baked animal feed according to the invention 1. First, the ingredients of the group “meat” are placed in the cutter 5. These ingredients are located in containers 2 and optionally 3 (if separate containers, e.g. for meat of different animal species, are provided) and are conveyed from there to the cutter 5. 4 denotes perforated disks that are upstream from the cutter 5 and are used to crush at least the flesh-based products for producing the feed precursor. After mincing in the cutter 5, the feed precursor is sent to an extruder 6 for extrusion. After extrusion 6, the shaped feed precursor is optionally heated (not shown in FIG. 1) and the animal feed meat product 7 is obtained. This animal feed meat product 7, consisting for example of poultry meat, is then added to a baked product dough produced in parallel (production of the baked product dough is not shown in FIG. 1). After this—before drying to obtain the baked animal feed 1—the baked product dough containing the animal feed meat product 7 is pressed through a die 8, and this dough is cut e.g. into cubes or cuboids by a cutting device 9 such as a rotating knife. After this, the baked product dough containing the animal feed meat product 7 is dried in the dryer 10 to obtain baked animal feed 1.

The size of the baked animal feed 1 is selected so that it can be optimally consumed by the respective carnivorous animal species; for example, the diameter for cat biscuits is approximately 1 cm, while it can be approximately 2 to 4 cm for dogs. After drying, the final product, i.e. the baked animal feed 1, is conveyed to processing and/or packaging units (not shown in FIG. 1).

1. A method for producing baked animal feed containing an animal feed meat product that is optionally in pieces, comprising the steps of:
a) charging a cutter for producing an animal feed precursor with ingredients comprising at least one meat having a temperature equal to or lower than +25° C,
b) mincing the ingredients in the cutter into a feed precursor with a moisture content of between 40 wt % and 80 wt % so that an animal feed meat product is obtained,
c) adding the animal feed meat product to a baked product dough, and
d) drying the baked product dough containing the animal feed meat product to a moisture content of the baked animal feed between 2 wt % and 20 wt %.

2. The method according to claim 1, wherein after the mincing according to step b) and before step c), the feed precursor is shaped.

3. The method according to claim 1, wherein the minced feed precursor is heated to a temperature of between 70° C. and 120° C. to obtain the animal feed meat product.

4. The method according to claim 1, wherein the ingredients for producing the feed precursor are rued in a completely or partially frozen form.

5. The method according to claim 1, wherein the baked product dough contains one or a plurality of the following components: biscuit meal, cereal flour, water, meat-and-bone meal, vegetable flour, and/or vegetable granulate, and/or vegetable flakes, natural lignocellulose, pyrophosphate, and linseed.

6. The method according to claim 1, wherein before mincing in the cutter, one or a plurality of components selected from the group of phosphate, salt, plasma and gluten are added to the ingredients for producing the feed precursor.

7. The method according to claim 1, wherein before being added to the baked product dough, the animal feed meat product is optionally shaped into irregular pieces and/or pieces having the appearance of meat.

8. The method according to claim 1, wherein the baked product dough and/or the feed precursor is mixed with at least one additive selected from the group consisting of flavoring agents, natural or synthetic dyes, inactivated yeast or yeast extracts, plant extracts or concentrates, preservatives, sugars, and functional ingredients.

9. The method according to claim 1, wherein before drying into baked animal feed, the baked product dough containing the animal feed meat product is pressed through a die, and is optionally cut by means of a cutting device.

10. Baked animal feed obtainable by a method according to claim 1.

11. The baked animal feed according to claim 10, wherein part or all of the obtained animal feed meat product is present in the baked animal feed in visible pieces, which optionally are irregularly shaped and/or have the appearance of pieces of meat.

12. The baked animal feed according to claim 11, wherein the pieces of meat have a mean diameter of approximately 0.5 cm to approximately 1.5 cm.

13. The baked animal feed according to claim 10, wherein the obtained animal feed meat product is in pieces, which are distributed in the baked animal feed in an essentially even manner.

14. The baked animal feed according to claim 10, wherein said feed is dyed in one or more colors with natural and/or synthetic dyes.

15. The baked animal feed according to claim 10, wherein said feed is in the form of biscuits.

16. The baked animal feed according to claim 10, wherein said feed is sealed in a tubular bag package, a hollow shell package, a can, or a box.

17. The baked animal feed of claim 15, wherein said feed is in the form of cubiods, cubes, or cakes.

18. The method according to claim 2, wherein the feed precursor is shaped by extrusion.
